(19) United States
(12) Patent Application Publication
(10) Pub. No.: US 2022/0019944 A1
(43) Pub. Date: Jan. 20, 2022

(54) SYSTEM AND METHOD FOR IDENTIFYING AND MITIGATING AMBIGUOUS DATA IN MACHINE LEARNING ARCHITECTURES

(71) Applicant: Singulos Research Inc., Burnaby (CA)

(72) Inventors: Bradley Quinton, Vancouver (CA); Trent McClements, Burnaby (CA); Michael Lee, North Vancouver (CA); Scott Chin, Vancouver (CA)

(21) Appl. No.: 17/378,603

(22) Filed: Jul. 16, 2021

Related U.S. Application Data
(60) Provisional application No. 63/052,784, filed on Jul. 16, 2020.

(51) Int. Cl. G06N 20/20; G06K 9/62; G06T 19/00

(52) U.S. Cl. CPC G06N 20/20; G06T 19/006; G06K 9/6228; G06K 9/6256

(57) ABSTRACT

Machine learning systems are valuable for processing data in many scenarios including understanding objects and the environment in mixed reality systems. The present disclosure provides ambiguity-aware machine learning methods and systems that are capable of identifying input data that will potentially lead to erroneous predictions arising from training data ambiguity; capable of learning to identify training data as ambiguous during the training process; and, capable of adjusting the training process to account for training data that is Ambiguous.

### CROSS REFERENCE

This application claims the benefit of priority of U.S. Provisional Patent Application No. 63/052,784 filed on Jul. 16, 2020, the entirety of which is incorporated herein by reference.

### FIELD

The present disclosure relates to machine learning systems, and more particularly to machine learning systems capable of identifying and mitigating ambiguous data.

### BACKGROUND

Machine learning systems are useful in cases where the underlying function is unknown and/or difficult to ascertain, but where examples of the relationship between input data and the desired labels is available. These systems can often produce solutions that are valuable and more accurate than other prediction approaches.

Machine learning systems are systems that may be trained to process and analyze specific data sets to produce a decision or judgement. Machine learning systems may be trained by using a set of example inputs (input data) coupled with a set of desired outputs (labels) (collectively, training data), in what is often referred to as “supervised machine learning”. Each example in the training data can be viewed as an element of the training data. Using various search and optimization processes (e.g. gradient descent, backpropagation and others), the internal states of the machine learning system (the parameters) are iteratively adjusted based on the training data such that the overall error in predicting the known output labels on the training data is minimized (the training process). There are many ways to implement a machine learning system, including using artificial neural networks, recurrent neural networks, convolutional neural networks, logistic regression, support vector machines, etc.

Once sufficiently trained, the performance of a machine learning system can be evaluated using test data. The test data is composed of input data and known correct labels. Typically, the test data is not used in the training process and can therefore be considered an independent evaluation of the expected performance of the system. To do this, the machine learning system can be presented with new, previously unseen input data from the test data and it will, with some probability, produce the desired label. Given that the test data are different from those in the training data set, the label generated by the machine learning system for each input data in the test data can be viewed as a prediction, meaning that the machine learning system makes predictions based on what it has learned during the training process. If the predicted label of the trained machine learning system does not match the known correct label for that input in the test data set, then the machine learning system is considered to have made an error.

Once trained and tested, machine learning systems can be used to generate predicted labels for never before seen input data. Often this input data is supplied by another higher-level system and the predicted labels are passed back to the higher-level system, which may be referred to as the deployed scenario.

If the test data set utilized during the evaluation performed after training was sufficiently large, and sufficiently representative of the input data for which the machine learning system is expected to experience in a deployed scenario, then the error rate on the test data can be considered an approximation of the error rate in the deployed scenario. However, it may be challenging to obtain a desirable error rate utilizing conventional machine learning techniques.

One example of a deployed scenario is in a mixed reality system. Mixed reality is any interactive experience where the user can interact, in real-time, with real-world objects and virtual-objects, and the real and virtual objects may also interact with each other. A system that implements mixed reality, a mixed reality system, needs to interpret and understand the physical environment in which it operates. A common way that mixed reality systems facilitate this is to include one or more sensors such as, but not limited to, image sensors which produce image data. Mixed reality systems may use machine learning systems to interpret the sensor data to understand the physical objects in the environment. In such an implementation, the input to the machine learning system may be the sensor data, and the output may be a set of predictions for the location of objects of interest and/or the kind of the objects.

Improvements to machine learning systems are desired.

### BRIEF DESCRIPTION OF THE DRAWINGS

Embodiments of the present disclosure will now be described, by way of example only, with reference to the attached Figures.

FIG. 1 illustrates a training process for a conventional machine learning system;

FIG. 2 illustrates a testing process for a conventional machine learning system trained in accordance with the training process of FIG. 1;

FIG. 3 illustrates a deployed machine learning system trained in accordance with the training process of FIG. 1 and optionally tested in accordance with the testing process of FIG. 2;

FIG. 4 illustrates an embodiment of a training process for an ambiguity-aware machine learning system in accordance with the present disclosure;

FIG. 5 illustrates an embodiment of a training process for an ambiguity-aware machine learning system in accordance with the present disclosure wherein the set of training data includes ambiguity labels;

FIG. 6 illustrates an embodiment of a deployed ambiguity-aware machine learning system having a multi-output ambiguity-aware prediction engine in accordance with the present disclosure;

FIG. 7 illustrates an embodiment of a deployed ambiguity-aware machine learning system having an ambiguity-aware prediction engine with an encoded ambiguity-aware output prediction label in accordance with the present disclosure;

FIG. 8 illustrates an embodiment of a deployed ambiguity-aware machine learning system having a multi-output ambiguity-aware machine learning engine in accordance with the present disclosure;

FIG. 9 illustrates an embodiment of a deployed ambiguity-aware machine learning system having a multi-output ambiguity-aware machine learning engine based on activation values in accordance with the present disclosure;

FIG. 10 is a diagram for an embodiment of a mixed-reality system having an ambiguity-aware machine learning system in accordance with the present disclosure illustrating acquiring multiple perspectives of an object to resolve ambiguity;

FIG. 11 is a block diagram of an example computing device or system for implementing an ambiguity-aware machine learning system and method in accordance with the present disclosure.

Throughout the drawings, sometimes only one or fewer than all of the instances of an element visible in the view are designated by a lead line and reference character, for the sake only of simplicity and to avoid clutter. It will be understood, however, that in such cases, in accordance with the corresponding description, that all other instances are likewise designated and encompasses by the corresponding description.

### DETAILED DESCRIPTION

The following are examples of an ambiguity-aware machine learning system and method in accordance with the disclosure herein.

According to an aspect, the present disclosure provides a method of generating a prediction output in a machine learning system having a machine learning engine and a prediction engine, the method comprising receiving a data input at the machine learning engine; generating, by the machine learning engine, an output associated with the data input based on a set of internal parameters and transmitting the output to the prediction engine; determining, at the prediction engine, a label from a set of possible labels and an ambiguous indication based on the output of the machine learning engine and a prediction function; generating a prediction output that indicates the determined label and the determined ambiguous indication.

In an embodiment, determining the ambiguous indication comprises comparing the machine learning engine output to a criterion; and, if the criterion is not met, the determined ambiguous indication indicates that the determined label is ambiguous.

In an embodiment, the output generated by the machine learning engine is an output vector where each location of the vector output is associated with a label from the set of possible labels; the criterion is a minimum threshold value; and comparing the output to the criterion comprises comparing the largest value of the output vector to the minimum threshold value such that the criterion is not met if the largest value does not exceed the minimum threshold value.

In an embodiment, the criterion further includes a second threshold value; and comparing the machine learning engine output to the criterion further comprises comparing each value of the output vector other than the largest value to the second threshold value such that the criterion is not met if any of the other values exceed the second threshold value.

In an embodiment, generating, by the machine learning engine, an output associated with the data input comprises generating, by the machine learning engine, an additional output to provide additional information to the prediction engine for determining the ambiguous indication.

In an embodiment, determining, by the prediction engine, the ambiguous indication comprises comparing the additional output generated by the machine learning engine to pre-defined conditions; and if the additional output meets pre-defined conditions, the determined ambiguous indication indicates that the determined label is ambiguous.

In an embodiment, determining the ambiguous indication comprises comparing the additional output from the machine learning engine to a criterion; and, if the additional output does not meet the criterion, the ambiguous indication is asserted.

In an embodiment, further performing a training process by the machine learning engine utilizing training data and a cost function to determine the set of internal parameters, utilizing the cost function to calculate a cost associated with the determined ambiguous indication indicating that the label determined by the prediction engine is ambiguous by not meeting the criterion.

In an embodiment, the cost function is a sum of a cost associated with incorrectly determining the ambiguous indication as indicating the determined label is not ambiguous and a cost associated with incorrectly determining the ambiguous indication as indicating the determined label is ambiguous.

In an embodiment, the additional output generated by the machine learning engine is associated with an indication of ambiguity of a data input.

In an embodiment, performing a training process by the machine learning engine utilizing training data and a cost function to determine the set of internal parameters, wherein the training data utilized in the training process includes a subset of the training data that includes ambiguity indications indicating that the training inputs in the subset of training data may be considered ambiguous.

In an embodiment, the cost function is configured to calculate the cost associated with the additional output generated by the machine learning engine.

In an embodiment, the determining, at the prediction engine, the label and the ambiguous indication utilizes the additional output generated by the machine learning engine.

In an embodiment, the additional output is generated by the machine learning engine is a function of the internal activations of the machine learning engine.

In an embodiment, the function is comprised of vector distances between the activations associated with each of the outputs generated by the machine learning engine for a set of data inputs.

In an embodiment, further performing a training process by the machine learning engine utilizing training data and a cost function to determine the set of internal parameters, wherein the cost function is configured to add an additional cost for each of the additional outputs that indicates the training input is ambiguous that exceeds a threshold number of ambiguous outputs.

According to an aspect, the present disclosure provides machine learning system comprising a machine learning engine configured to receive a data input; and generate an output associated with the data input based on a set of internal parameters and transmitting the output to the prediction engine; and a prediction engine configured to: determine a label from a set of possible labels and an ambiguous indication based the machine learning engine output and a prediction function; and generate a prediction output that indicates the determined label and the determined ambiguous indication.

In an embodiment, the prediction engine configured to determine the ambiguous indication comprises the prediction engine configured to: compare the machine learning engine output to a criterion; if the criterion is not met, the determined ambiguous indication indicates that the determined label is ambiguous.

In an embodiment, the machine learning engine configured to generate the output generated comprises the machine learning engine configured to generate an output vector where each location of the vector output is associated with a label from the set of possible labels; the criterion is a minimum threshold value; and the prediction engine configured to compare the output to the criterion comprises the prediction engine configured to compare the largest value of the output vector to the minimum threshold value such that the criterion is not met if the largest value does not exceed the minimum threshold value.

In an embodiment, the criterion further includes a second threshold value; and the prediction engine configured to compare the machine learning engine output to the criterion further comprises the prediction engine configured to compare each value of the output vector that are other than the largest value to the second threshold value such that the criterion is not met if any of the other values exceed the second threshold value.

In an embodiment, by the machine learning engine configured to generate an output associated with the data input comprises the machine learning engine configured to provide an additional output to generate additional information for determining the ambiguous indication.

In an embodiment, the Prediction Engine configured to determine the ambiguous indication comprises the prediction engine configured to compare the additional output generated by the Machine Learning Engine to pre-defined conditions; and if the additional output meets pre-defined conditions, the determined ambiguous indication indicates that the determined label is ambiguous.

In an embodiment, the prediction engine configured to determine the ambiguous indication comprises the prediction engine configured to compare the additional output from the Machine Learning Engine to a criterion; if the additional output does not meet the criterion is not met, the ambiguous indication is asserted.

In an embodiment, the machine learning engine is further configured to: perform a training process utilizing training data and a cost function to determine the set of internal parameters, utilize the cost function to calculate a cost associated with the determined ambiguous indication indicating that the label determined by the prediction engine is ambiguous by not meeting the criterion.

In an embodiment, the cost function is a sum of a cost associated with incorrectly determining the ambiguous indication as indicating the determined label is not ambiguous and a cost associated with incorrectly determining the ambiguous indication as indicating the determined label is ambiguous.

In an embodiment, the additional output generated by the machine learning engine is associated with an indication of ambiguity of a data input.

In an embodiment, the machine learning engine is further configured to perform a training process utilizing training data and a cost function to determine the set of internal parameters, wherein the training data utilized in the training process includes a subset of the training data that includes ambiguity indications indicating that the training inputs in the subset of training data may be considered ambiguous.

In an embodiment, the machine learning system is configured to utilize the cost function to calculate the cost associated with the additional output generated by the machine Learning engine.

In an embodiment, the prediction engine configured to determine the ambiguous indication comprises the prediction engine configured to utilize the additional output generated by the machine learning engine to determine the ambiguous indication.

In an embodiment, the additional output is generated by the machine learning engine is a function of the internal activations of the machine learning engine.

In an embodiment, the function is comprised of vector distances between the activations associated with each of the outputs generated by the machine learning engine for a set of data inputs.

In an embodiment, the machine learning engine is further configured to perform a training process utilizing training data and a cost function to determine the set of internal parameters, wherein the cost function is configured to add an additional cost for each of the additional outputs that indicates the training input is ambiguous that exceeds a threshold number of ambiguous outputs.

According to an aspect, the present disclosure provides an ambiguity-aware machine learning system for identifying an object, comprising a user device having a sensor for acquiring information indicative of the object, the user device communicatively coupled to a processor configured by machine-readable instructions to generate image data based on the information acquired by the sensor, the image data indicative of a first perspective of the object; generate, using a machine learning engine, an output based on applying a set of machine learning parameters associated with the machine learning engine to the image data; generate, using a prediction engine, an output label and an ambiguous indication based on the machine learning engine output and a prediction function associated with the prediction engine, and generate a prediction output that includes the output label and the ambiguous indication corresponding to the object.

In an embodiment, the processor is further configured by the machine-readable instruction to compare the prediction output to a criterion, and output an indication that the output label is ambiguous if the prediction output does not meet the criterion.

In an embodiment, when the prediction output does not meet the criterion, the processor if further configured by the machine-readable instruction to generate the image data based on further information acquired by the sensors, the image data indicative of a further perspective of the object different from the first perspective of the object.

In an embodiment, when the prediction output does not meet the criterion, the processor is further configured by the machine-readable instruction to generate image data based on further information acquired by the sensor, the image data indicative of a plurality of perspectives of the object.

In an embodiment, the user device is a mixed-reality device and the sensor is a camera.

In an embodiment, the mixed-reality device is a headset having a heads-up display.

In an embodiment, when the prediction output does meet the criterion, the object is identified and visualized on a display associated with the user device, wherein the object is displayed with an advertisement or social media interaction associated with a class or characteristic of the object.

According to an aspect, the present disclosure provides a method for training a machine learning system to identify and mitigate ambiguity, the method comprising: training a machine learning engine using a training set comprising a plurality of input data associated with a corresponding plurality of known labels, wherein a subset of the plurality of input data is further associated with a corresponding ambiguity label; generating, during training of the machine learning engine, for each of the plurality of input data in the training set, a first machine learning output indicative of a potential label associated with an input data and a second machine learning output indicative of a potential ambiguity associated with the input data; generating, using a cost function, a cost output for each of the plurality of input data based on the first machine learning output and the second machine learning output; adjusting a set of parameters associated with the machine learning engine based on the cost function, wherein the set of associated parameters condition the behaviour of the machine learning engine.

In an embodiment, the subset of inputs is all of the plurality of input data.

In an embodiment, the cost function is configured to limit the use of ambiguous labels.

In an embodiment, the cost output includes a first cost based on comparing the first machine learning output with a known label associated with the input data, and a second cost based on comparing the second machine learning output with, if available, an ambiguity label associated with the input data.

In an embodiment, the cost function assigns the known label or the ambiguity label to the cost output based on a relative difference between the first cost and the second cost.

In an embodiment, the first cost is based on miss-predicting that the input data should have the potential label corresponding to the first machine learning output and miss-predicting that the input data should not have the potential label corresponding to the first machine learning output.

In an embodiment, the second cost is based on miss-predicting that the input data should have the potential ambiguity associated with the second machine learning output and miss-predicting that the input data should not have the potential ambiguity associated with the second machine learning output.

In an embodiment, further annotating the set of training data to include a plurality of desired responses correspondingly associated with the plurality of input data.

In an embodiment, further generating a plurality of desired responses based on applying an unsupervised learning process to the second machine learning output and annotating the set of training data to correspondingly associate the plurality of desired responses with the plurality of input data.

In an embodiment, the desired response is an indication of ambiguity based on applying a clustering algorithm to the plurality of input data.

In an embodiment, the training process further comprises an ambiguous budget for limiting a number of the plurality of input data that can be considered ambiguous.

In an embodiment, the cost function generates a first penalty for an incorrect prediction and generates a second penalty for exceeding the ambiguous budget.

In an embodiment, the incorrect prediction is based on a Binary Cross-Entropy Loss function for quantifying a correctness of a prediction.

Machine learning systems are capable of learning to predict labels based on training processes having training data comprising inputs and associated labels. Subsequent testing processes may be used to validate the efficacy of the training process before deploying the machine learning system. In a deployed state, the machine learning system predicts a label for a given input on the basis of the configuration conditioned by the training process.

Generally, machine learning systems include a machine learning engine and a prediction engine. Other configurations are possible. The machine learning engine also includes parameters for conditioning calculations internal to the machine learning engine, including conditioning combinations of the calculations, including the combination which results in the machine learning engine output of the system. A neural network for example, can be implemented as a machine learning engine, where calculations internal to the neural network may be viewed as feature detectors, and the output of the feature detectors are typically referred to as activations. More generally however, calculations internal to a machine learning engine may be any type of internal calculation natural to the particular type of machine learning engine. For the sake of simplicity, regardless of the type of machine learning engine, all results of internal calculations will be referred to herein as activations.

During the training process, parameters associated with the machine learning engine are adjusted. Once training is complete, the parameter values are fixed. The fixed parameter values along with the fixed computational relationships of the machine learning engine and the prediction engine define the processing capabilities of the machine learning system and can be used to predict a label for a given data input. For example, the machine learning engine provides an output for a given input to a prediction engine for use in predicting a label associated with the given input. In this regard, the training process can be thought of as the process of finding a set of parameters for a given machine learning system that achieves a desired prediction goal for the system.

Conventionally, training data comprises a plurality of training elements, each training element having an input data and an associated label or desired label. Examples of labels include numeric or symbolic values. For example, the label may be a “one-hot” encoded vector with a length equal to the number of valid labels, with each position in the vector being used to represent each different label such that a value of ‘1’ in the position corresponding to a specific label and values of ‘0’ in all other locations represents another specific label. Many other label definitions are possible.

During the training process a cost function evaluates outputs provided by the machine learning engine against the corresponding desired label from the training data. Typically, the cost function is applied directly to the outputs of the machine learning engine, independent of a prediction engine. Examples of cost functions include but are not limited to: binary cross entropy, categorical cross entropy, r-squared, etc. Further, a custom-designed cost function for a specific scenario may also be used. The cost function acts as a proxy for results generated by the prediction engine, in the sense that lowering the cost should lead to more accurate predictions from the prediction Engine (however, this is not strictly true, and it is possible that lowering the cost according to the cost function does not improve the accuracy of the predicted labels). The cost function results (e.g. the cost) are used to guide the update of the parameter values which condition the behaviour of the machine learning engine with the goal of finding a set of parameter values which optimizes or lowers the cost. This can be done with a number of search and optimization methods including but not limited to: gradient descent, backpropagation, etc. The training process proceeds iteratively, updating the parameter values and evaluating the cost function until achieving a training cost goal, achieving a maximum number of iterations, or achieving a desired condition or constraint.

Once the training process is complete, the cost function is replaced with a prediction engine applied to the output of the machine learning engine, to map machine learning engine outputs to label predictions. Once the prediction engine is implemented, the machine learning system may undergo testing with a testing data set to evaluate the performance of the trained machine learning engine, or may be deployed to make predictions on given input data. Many prediction engine implementations are possible. For example, in the case where the output is a vector, the prediction engine may consider all the vector locations and then select the label corresponding to the location of the element with the largest value in the vector.

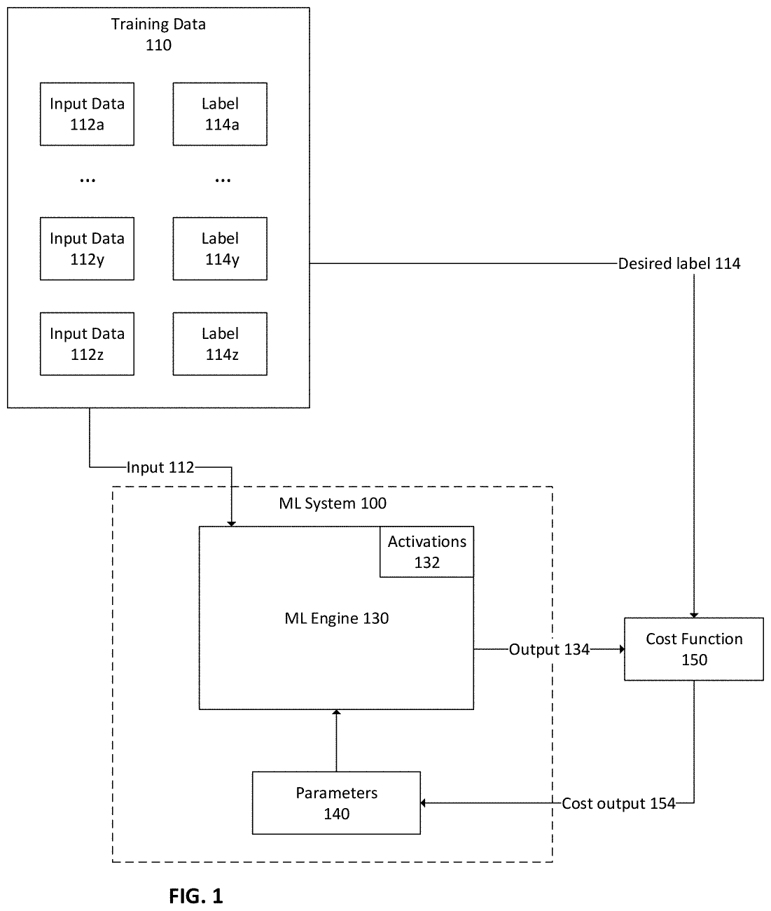

FIGS. 1-3 illustrate example processes respectively for training, testing, and deploying previous machine learning systems. FIG. 1 illustrates a training process for a previous machine learning system 100 which trains on a set of training data 110. The training data 110 consists of a plurality of training elements, namely a plurality of input data 112a, . . . , 112y, 112z paired with a corresponding plurality of labels 114a, . . . , 114y, 114z. The machine learning system 100 includes a machine learning engine 130 having an associated set of activations 132 and associated set of parameters 140. During the training process, the machine learning engine 130 receives an input 112 corresponding to one of the plurality of input data 112a, . . . , 112y, 112z. For each input 112 received, the machine learning engine 130 generates an output 134 as a function of the parameters 140. The machine learning engine 130 provides the output 134 to a cost function 150 for comparison with a label 114 of the plurality of labels 114a, . . . , 114y, 114z that pairs with the corresponding input 112. Based on the comparison, the cost function 150 generates a cost output 154 for use in tuning the parameters 140. This training process repeats until achieving a desired training goal. The final parameters and the computational relationship (architecture) of the machine learning engine can be stored and represent the trained machine learning engine 130.

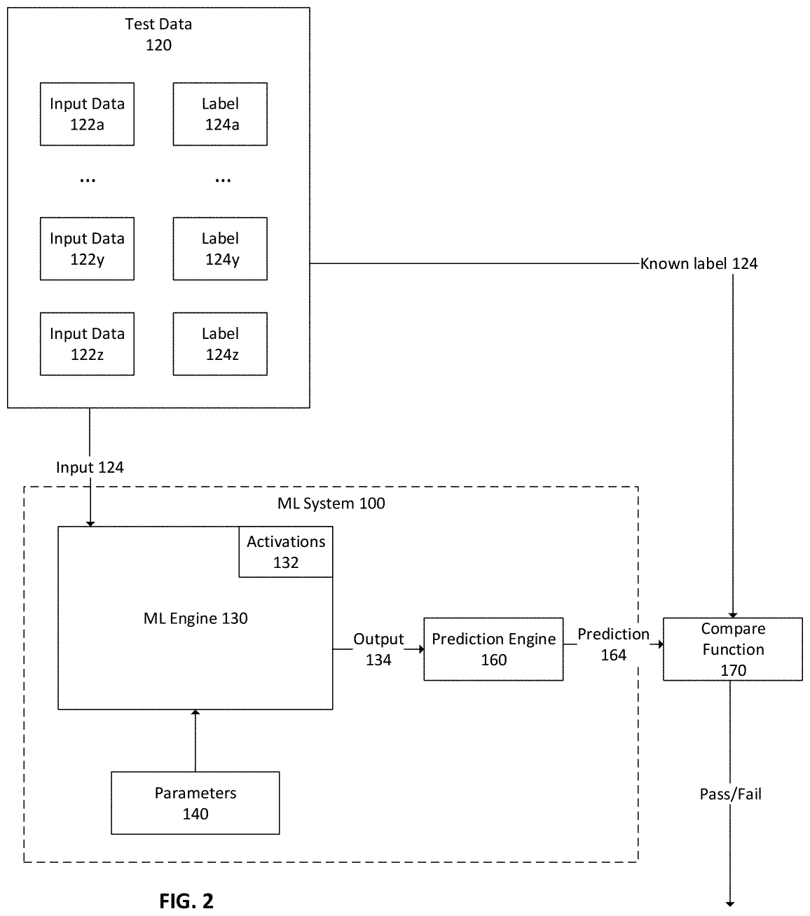

FIG. 2 illustrates a testing process for a previous machine learning system 100 having a machine learning engine 130 trained in accordance with FIG. 1 and further including a prediction engine 160. The testing process can be applied to evaluate the trained machine learning engine 130 and parameters 140 using a set of test data 120 having a plurality of test elements, namely a plurality of test input data 122a, . . . , 122y, 122z paired with a corresponding plurality of known correct labels 124a, . . . , 124y, 124z. During the testing process, the machine learning engine 130 receives an input 122 corresponding to one of the plurality of test input data 122a, . . . , 122y, 122z. For each input 122 received, the machine learning engine 130 generates an output 134 as a function of the trained parameters 140. The machine learning engine 130 provides the output 134 to the prediction engine 160 for generating a predicted label 164 which is provided to a comparison function 170 for comparison against a known label 124 representing a known correct label of the plurality of known correct labels 124a, . . . , 124y, 124z that pairs with the corresponding input 122. If the predicted label 164 and the known label 124 do not match, then an error is considered to have occurred. The testing process continues in order to analyze any errors and determine whether the machine learning system 100 has achieved a desired goal.

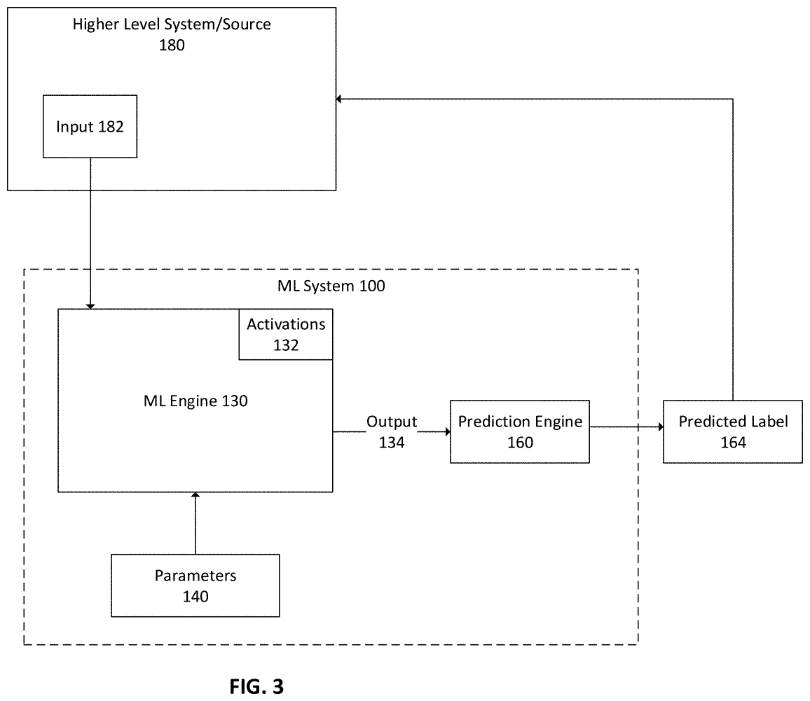

FIG. 3 illustrates a deployment scenario for a previous machine learning system 100 having a machine learning engine 130 trained in accordance with FIG. 1 and optionally tested in accordance with the process of FIG. 2. In the deployment scenario, the trained machine learning engine 130 receives an input 182 from an external source 180, such as a higher level system, sensor, or data file. The machine learning engine 130 applies the parameters 140 to the input 182 to generate an output 134 which inputs to the prediction engine 160 for generating a predicted label 164. In the deployed scenario, there is no way to known whether the predicted label is correct or not.

A challenge with previous machine learning systems and engines is the inability to identify, train for, or otherwise mitigate ambiguity in input data. For example, previous machine learning systems, even after extensive training and/or iterative training, may generate erroneous predictions for a number of reasons, including but not limited to: mislabelled training data, incomplete training data, underfit from insufficient or ineffective training processes, overfit from insufficient or ineffective training processes, overly complex machine learning systems, lack of sufficient training data, and ambiguous cases in the training and/or test data. Ambiguity in particular can arise where elements in the training data or test data lack sufficient differentiating information from one-another despite having different associated labels. In other words, conventional machine learning systems cannot adequately predict labels due to limitations in training on data having similar inputs but different associated labels. Consequently, the machine learning engine may be erroneously trained to assign the same label or output to similar inputs, leading to erroneous predictions and negatively influencing the overall efficiency and effectiveness of the training process, even for non-ambiguous data (e.g. by producing overfit or underfit). Overfit in particular may give rise to unjustifiable passes where, though the machine learning system correctly predicts the label for the associated input data, it does so for the wrong reasons. In other words, the system got lucky but disadvantageously provides no indication of the improper configuration that will inevitable lead to erroneous predictions. Some systems in particular, such as mixed-reality systems, may tolerate minimal to no error from a deployed machine learning system, and thus may not be suited for conventional machine learning systems. Within the context of image data of an object, a non-limiting list of sources of ambiguity include: lighting, the perspective, angle, rotation, or orientation of the object, overlap, noise, superfluous information, and/or other factors that mitigate, mask, blur, or otherwise make difficult, the ability to distinguish an object from a different object.

Conventional machine learning engines, such as those illustrated in FIGS. 1-3, typically generate labels in a normalized numeric format, ranging between two bounding values (e.g., between ‘0’ and ‘1’). These outputs are normally passed to a prediction engine to predict a label. However, these normalized outputs do not necessarily indicate a measure of confidence in the prediction. Rather, conventionally trained machine learning systems generate these values as a result of adjusting parameters during the training process to minimize the overall system cost function on the training. Because of the potential for overfit or underfit in the training process, high numeric value outputs may actually be incorrect. Furthermore, even in the absence of underfit or overfit, there may exist input data which leads to the machine learning engine generating outputs with high numerical values depending on the frequency of other similar data with different labels in the training data (i.e. the relative frequency of different ambiguous cases in the training data). This happens because the goal in conventional machine learning training processes is to minimize the overall training cost, not the production of an estimation of the probability of correct label predictions for any given input data.

Under conventional machine learning techniques, there is no effective, efficient, and reliable way to create a machine learning system that can identify input data as being at risk of erroneous predictions because of ambiguity in the training data, nor is there a way for the machine learning system to learn which training data is ambiguous in order to minimize the overall prediction error of the system, such as, for example, avoiding overfit/underfit caused by ambiguous training data.

In an aspect disclosed herein is an ambiguity-aware machine learning system that employs methods and apparatuses to mitigate the negative impact of ambiguity in input data. For a given input, the machine learning system disclosed herein provides an ambiguity-aware prediction which associates a suitable label (from a set of supported labels) or an ambiguous label with the given input data. The ambiguous label provides an indication of ambiguity in the given input data. The ambiguous label may be provided as a separate output or encoded in a prediction output with the suitable label from the set of supported labels. In this regard, higher-level systems which employ the ambiguity-aware machine learning system can first inspect the ambiguous indication before deciding how to interpret the predicted suitable label. Embodiments of an ambiguity-aware machine learning system as disclosed herein may include an ambiguity-aware machine learning engine and/or an ambiguity-aware prediction engine. Input data supplied to the ambiguity-aware machine learning engine generates an output as an encoding of the prediction for the corresponding input data. One example of a potential encoding in accordance with the disclosure herein includes providing the output as a vector of continuous values between “0” and “1” where each element of the vector corresponds to a label from a set of supported labels. The output of the ambiguity-aware machine learning engine is provided to a cost function during training, or to a ambiguity-aware prediction engine during testing or deployment. The ambiguity-aware prediction engine interprets the encoded output provided by the machine learning engine, to generate an ambiguity-aware prediction for the associated input data.

The present disclosure provides, in an aspect, machine learning systems and methods configured to account for ambiguity during training, testing, and deployment. Advantages of the machine learning systems and methods disclosed herein include but are not limited to: identifying input data that may potentially lead to erroneous predictions of ambiguity in the training data; learning to identify training data which includes ambiguity; and, adjusting training processes to account for ambiguity in training data. A machine learning system in accordance with the disclosure herein may be configured to generate either the correct label, or an indication of ambiguity, rather than outputting an incorrect label as in conventional machine learning systems. Embodiments of a machine learning system as disclosed herein include configurations for identifying input data at risk of incorrect prediction because of ambiguity in training data. Accordingly, embodiments of machine learning systems and methods as disclosed herein mitigate the impact of ambiguous training data on the ability of the machine learning system to make correct predictions.

The machine learning systems and methods disclosed herein include training processes which differ from conventional systems and methods. For example, training processes in accordance with the disclosure here may learn to identify ambiguity in input data and further adapt the training process in light of the ambiguity in the training data to minimize the overall system error. In the present disclosure, the determination by the machine learning system of whether any given training data element is ambiguous may be based on the capabilities of the machine learning system itself, the extent of the training process and the nature of the training data. Therefore, embodiments described herein include machine learning systems and methods that learn which training data is ambiguous in the context of, and simultaneous with, the overall training process. In an aspect, the machine learning systems and methods disclosed herein may have application in a variety of fields, including for object recognition and identification, as may be particularly suited for mixed-reality applications where ambiguous data arising from mixed reality system sensors can be better identified and mitigated to provide a better overall user experience.

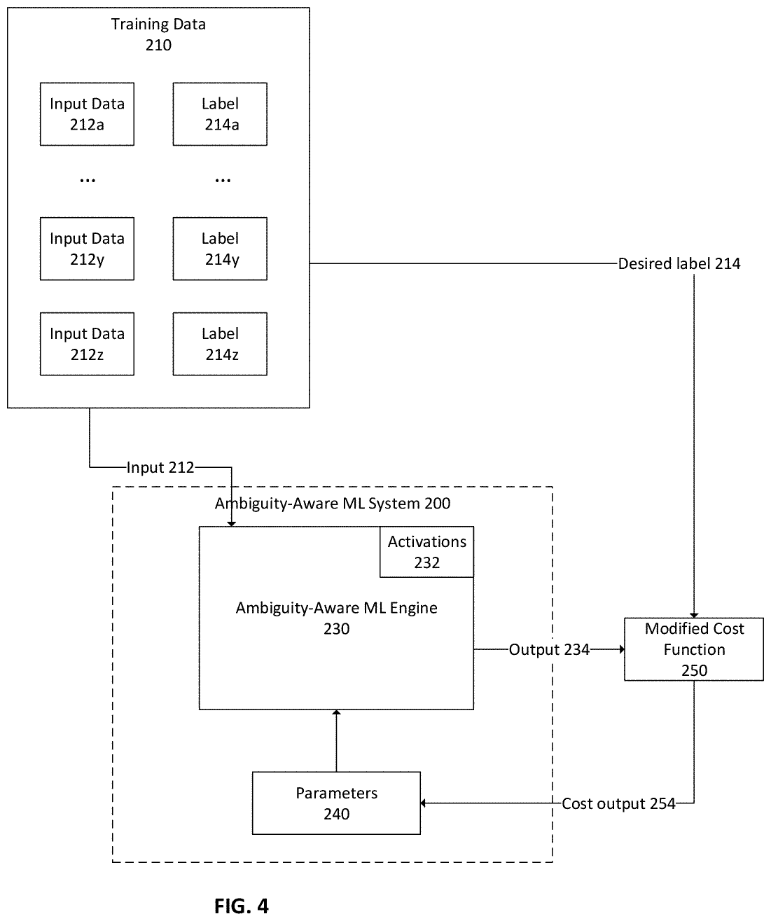

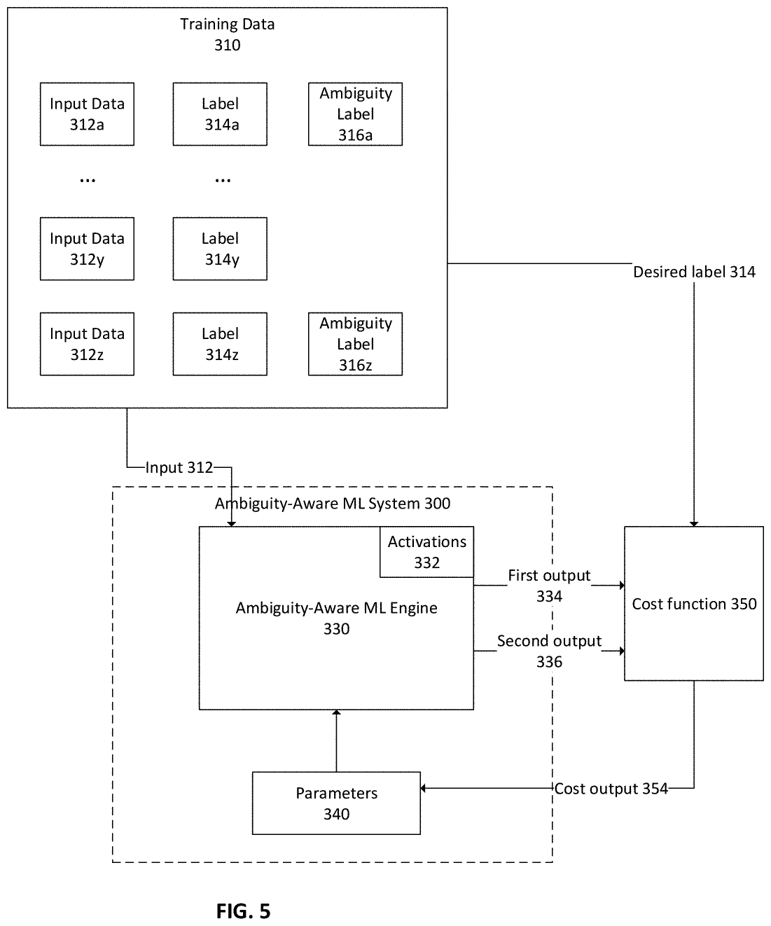

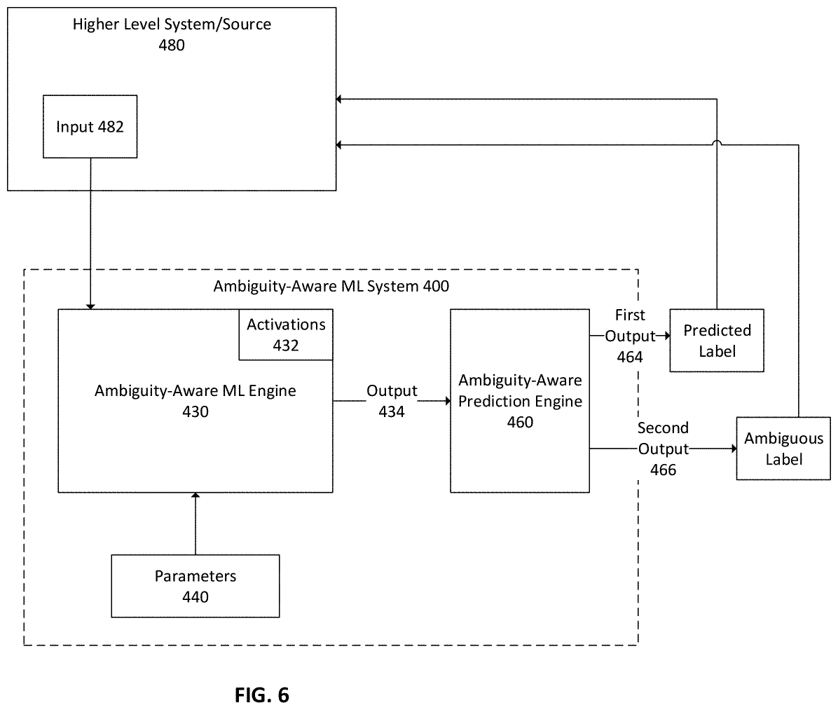

FIGS. 4 and 5 illustrate embodiments of a training process for an ambiguity-aware machine learning system in accordance with the disclosure herein. FIG. 4 illustrates an embodiment of a training process for an ambiguity-aware machine learning system 200 in accordance with the disclosure herein which trains on a set of training data 210. The training data 210 consists of a plurality of training elements comprising a plurality of input data 212a, . . . , 212y, 212z paired with a corresponding plurality of labels 214a, . . . , 214y, 214z. The machine learning system 200 includes a modified cost function 250 and/or modified encoding for the output 234 of the ambiguity-aware machine learning engine 230. The modified cost function 250 and modified output 234 are more amenable for use with a prediction engine that has been enhanced to produce an ambiguous indication as illustrated for example by the ambiguity-aware prediction engines in FIGS. 6-9. For example, the cost function 250 may be enhanced to account for the method in which a prediction engine will compute an ambiguous indication, explicitly encouraging the machine learning engine 230 to achieve parameters 240 which condition the machine learning engine 230 to provide outputs 234 that are more effective for a prediction engine to use for determining whether input data should be classified as ambiguous or not.

Embodiments of an ambiguity-aware machine learning engine may be configured such that its outputs are more amenable for use with an ambiguity-aware prediction engine in accordance with the disclosure herein, such as those illustrated in FIGS. 6-9. This can be achieved by incorporating the ambiguity-aware prediction engine's criterions into the training process, and/or the computational relationships of the ambiguity-aware machine learning engine. One way to facilitate this would be to choose a computational relationship and training cost function that encourages the trained machine learning engine to produce an output that is easier for the ambiguity-aware prediction engine's function to discern between making an ambiguous prediction or not.

Embodiments of a cost function in accordance with the disclosure herein include computing a cost function for each individual training data element. For example, computing a cost for each input data against each possible label, the cost having two components: a cost for mis-predicting that the input data should have a given label, and a cost for mis-predicting that the input data should not have the given label. The total cost (i.e. the overall cost function) is a combination of these cost components across all training data elements and labels (e.g. the plurality of input data and the plurality of labels). One possible way to combine the cost components is by summing them. One possible expression for such a cost function is as follows:

$$Cost = {\sum }_{i = 1}^{m} {\sum }_{j = 1}^{N} ( Mispredict\_Is \_Label ( {x}_{i} , j ) + α \cdot Mispredict\_Is \_Not \_Label ( {x}_{i} , j ) )$$

where:
N is the number of Labels in the set of Supported Labels
j is the index of Label j,
m is the number of Training Data Elements,
i is the index of the i-th Training Data Element,
xᵢ is the Input Data of Training Data Element i,
Mispredict_Is_Label(xᵢ,j) is the computed cost for mis-predicting that the i-th Training Data Elemen's Input Datat should have Label j,
Mispredict_Is_Not_Label(xᵢ,j) is the cost for mis-predicting that the i-th Training Data Element's Input Data should not have Label j, and
α is a tuning factor that determines the contribution of the cost of mis-predicting that some Input Data should have some label versus that it should not have the label.

The optimal value of a is dependent on the nature of the training data, the capabilities of the machine learning system and the desired balance between the possibility of mis-prediction and the propensity to label an input data as ambiguous. One possible method of determining α empirically is by re-training the machine learning engine with the same training data and different values for α until the desired result is achieved on the test data, which may be referred to as adjusting a hyperparameter of the machine learning system.

As a further example, the computational relationships of the machine learning engine may be configured as that of a neural network whose outputs are configured to use the Sigmoid activation function, and the training cost function may be configured as the following:

$$Cost = {\sum }_{i = 1}^{m} {\sum }_{j = 1}^{N} - ( {y}_{j}^{( i )} \cdot log ( {\hat{y}}_{j}^{( i )} ) + α \cdot ( 1 - {y}_{j}^{( i )} ) \cdot log ( 1 - {\hat{y}}_{j}^{( i )} ) )$$

where:
N is the number of Labels in the set of Supported Labels
j is the index of Label j,
m is the number of Training Data Elements,
i is the index of the i-th Training Data Element,
yⱼ⁽ⁱ⁾ is the value 1 if the Input Data of Training Data Element i should yield a Prediction of Label j and 0 otherwise
ŷⱼ⁽ⁱ⁾ is the Machine Learning Engine output corresponding to Label j for the Input Data of Training Data Element i
α is a tuning factor that determines the contribution of the cost of mis-predicting that some Input Data should have some label versus that it should not have the label.

An ambiguity-aware machine learning engine configured according to the foregoing concept can improve the ability of a machine learning system to determine ambiguous input data, and may further mitigate the training impact, such as overfit and underfit, of ambiguous training data in the training process. However, limitations on driving the cost to zero for all potential situations where there exists ambiguous training data is such that the possibility of overfit remains to some degree.

FIG. 5 illustrates an embodiment of training process in accordance with the disclosure herein, for an ambiguity-aware machine learning system 300 in accordance with the disclosure herein, such as the ambiguity-aware machine learning system 200 disclosed in FIG. 4. The training process illustrated in FIG. 5 is configured to directly learn to identify ambiguity in input data by providing a set of enhanced training data 310 having a plurality of input data 312a, . . . , 312y, 312z paired with a corresponding plurality of labels 314a, . . . , 314y, 314z. The set of training data 310 is enhanced to include one or more indications of ambiguity, such as an ambiguity label, for corresponding input data. For example, input data 312a and 312z have corresponding ambiguity labels 316a and 316z, denoting that the corresponding input data may be potentially considered as an ambiguous input, whereas input data 312y does not have a corresponding indication of ambiguity. The ambiguity-aware machine learning engine 330 is enhanced to produce an additional output 336 corresponding to an ambiguous label in a manner consistent with how other machine learning outputs may each correspond to one label in the set of labels supported by the machine learning system. The training process and cost function may be enhanced in several ways as disclosed herein. In an embodiment, the training process may be employed such that each of the plurality of input data 312a, . . . , 312y, 312z continues to be associated with a corresponding label of the plurality of labels 314a, . . . , 314y, 314z. In the case where an input data also has a corresponding ambiguous label (e.g. 316a, 316z), the training process may be configured to always associate the corresponding input data (e.g. 312a and 312z) with the ambiguous label. The training process may then proceed as in a conventional manner.

In an embodiment, the enhanced training data 310 includes an ambiguous label for each of the plurality of input data 312a, . . . , 312y, 312z. Accordingly, each training element in the set of training data 310 includes an input data paired with a corresponding ambiguous label in addition to being paired with a corresponding known label. In such an embodiment, the cost function 350 may be further configured to limit the use of ambiguous designations. For example, the limit may prevent the machine learning system 300 from indicating that all input data is ambiguous, as there is no external signal for the training process to determine which input data should be considered as potentially being ambiguous since all data includes an ambiguous label. In this regard, the training process may be configured as a combined supervised and unsupervised training process which simultaneously attempts to minimize the error in the predictions made by the machine learning system, while also limiting the proportion of predictions that indicate that the input data should be considered ambiguous. For example, the supervised learning aspect relates to using the known correct labels to train machine learning system outputs in the case that the input data is not deemed ambiguous; while the unsupervised learning aspect relates to training which input data is ambiguous under the notion that only a subset of the training data should be allowed to be considered as ambiguous.

In an embodiment, the cost function 350 may be configured to apply an ambiguous label or a desired label from the set of enhanced training data 310 to the outputs 334 and 336 of the machine learning engine 330 in each iteration of the training process. For example, the cost function may compute a first cost output associated with the known/desired label and a second cost output associated with the ambiguous label, and then provide a cost output 354 based on selecting a label (e.g. the ambiguous label or the desired label) based on a function. Such functions may include but are not limited to taking a relative difference between the first cost output and the second cost output and comparing to a threshold of the first and second cost outputs.

Embodiments of an ambiguity-aware machine learning engine may be configured to produce new outputs in addition to outputs corresponding to the supported labels for providing additional information to a prediction engine for aid in making predictions associated with the supported labels. In an embodiment, the additional output is an ambiguous label output for inputting to an ambiguity-aware prediction engine to enhance the engine's capability to determine whether to output a prediction of the ambiguous label or not. In an embodiment the ambiguous label output may be treated the same way as other outputs which each correspond to a supported label. In other words, that the set of supported labels has been increased to contain an additional label which is an ambiguous label.

In an embodiment, each training data element may be associated with exactly one label, wherein the one label is one of the supported labels or the ambiguous label and the training process can proceed as a traditional multiclass supervised learning process. In an embodiment, the one label is a label selected from a plurality of different types of labels. In an embodiment each training data element may have one label or two labels, for example, each training data element may have a label from the set of supported labels and optionally an ambiguous label, and the training process can proceed as a traditional multiclass supervised learning process.

In embodiments wherein the training data elements have two or more associated labels, the training process may be configured to dynamically learn to select only one label as the correct label using label overlap techniques. Such embodiments may use a custom cost function to incorporate the potential of training data elements having both ambiguous and non-ambiguous labels. For example, during each iteration of a training process, if the value for the machine learning engine output associated with the ambiguous label is larger than the value for the output associated with the non-ambiguous label, the cost component for the error for the output associated with the non-ambiguous label is set to zero, in other words, it is removed from the cost. As a further example, during each iteration of the training process if the value for the machine learning engine output associated with the ambiguous label is larger than the value for the output associated with the non-ambiguous label, then the cost component for the error for each output associated with a supported label are all set to zero, in other words they are all removed from the cost. As yet a further example, during each iteration of the training process if the value for the machine learning engine output associated with the ambiguous label is above a threshold, then the cost component for the error for the output associated with the non-ambiguous label is set to zero, in other words it is removed from the cost. As yet even a further example, during each iteration of the training process, if the value for the machine learning engine output associated with the ambiguous label is above a threshold, then the cost component for the error for each output associated with a supported label are all set to zero, in other words they are all removed from the cost. Other embodiments may include cost functions which implement combinations of the foregoing examples.

Embodiments of an ambiguity-aware machine learning system as disclosed herein may include applying a supervised learning training process to the ambiguous label output by including a desired response for the output in the set of training data. The process of annotating a desired response in training data for the ambiguous label output may be referred to as ambiguous label output annotation. Advantages of annotating a desired response in the training data include mitigating the training impact of overfit or underfit that ambiguous data may have on the training process. Other embodiments may include applying an unsupervised learning training process to the ambiguous label outputs. In such embodiments, the training data does not include a desired response for the ambiguous label output associated with the input data. However, the ambiguity-aware machine learning engine may be configured to learn a suitable desired response for the ambiguous label output during the training process. In other words, through the training process, the system learns which input data should be considered ambiguous.

Embodiments of ambiguous label output annotation may include utilizing a human expert to analyze the training data and identify elements of the training data for annotating. For example, the analysis may include identifying ambiguous input data and annotating accordingly.

Embodiments of an ambiguous label output annotation process may use a priori knowledge of the training data to automate annotating training data elements that should be considered ambiguous. For example, automated annotation may apply to classifying 2D images of 3D objects. Certain perspectives of the 3D object may not yield 2D images with enough information to allow for accurately predicting or identifying the 3D object on the basis of the 2D image. Consequently, the 2D image may be inherently ambiguous and annotating the data as such can be automated.

Embodiments of an ambiguous label output annotation process may apply iteratively, gradually annotating desired responses of the ambiguous label output. In an embodiment, the annotating process includes first annotating all training data as non-ambiguous, followed by performing the training process and analyzing failure patterns in the training data, and/or test data, and/or validation data. Based on these failure patterns, the desired response of the ambiguous label output for some subset of the data can be updated to indicate that they should be considered ambiguous. This process is repeated starting at the application of the training process. The process stops after meeting a training criterion, such as failure to further improve a training metric after an running an iteration of the training process or reaching a maximum number of iterations.

In an embodiment, analysis may be performed on the internal activations of the ambiguity-aware machine learning engine. Input data which yield identical or very similar internal activations may indicate ambiguity in the input data. Accordingly, the desired response of the ambiguous label output for the training data elements that may exhibit this behaviour may be updated to indicate ambiguity in the corresponding input data. Comparing all internal activations directly may however be computationally impractical. To alleviate this, embodiments in accordance with the disclosure herein may instead compare a function of the internal activations. In an embodiment, a subset of all internal activations may be compared, for example, as may be the case when a machine learning engine employs a convolutional neural network having a set of layers corresponding to the task of feature extraction, and another set of layers that correspond to classification. Comparing the activations of the final feature extraction layer would be a good candidate.

Embodiments of an ambiguous label output annotation process may be performed using an unsupervised learning training process. A model, which may be another machine learning system, analyzes the training data excluding their associated labels. Annotations of ambiguity may then be applied to similar input data in the set of training data. The degree of similarity required to trigger ambiguity between input data and the number of input data that can be annotated ambiguous can be controlled by the model. For example, a model may be developed using a clustering algorithm on the set of training data. Input data in the set of training data that cluster together may exhibit enough similarity for annotation as ambiguous. In other words, the distance from a training data element to a cluster centroid, can be interpreted as a metric of similarity. Training data elements with different labels that are close to the same cluster centroid can be interpreted as being ambiguous and can be annotated such. In an embodiment, the number of training data elements annotated as ambiguous can be limited and controlled. In the simplest case, this process can be configured such that only a fixed number of training data elements can be annotated as ambiguous. In an embodiment, the annotation process ranks training data elements based on their distance to cluster centroids whereby the training data elements closest to the cluster centroids are first selected for annotation as ambiguous.

Embodiments of an ambiguity-aware machine learning engine may be configured to generate an ambiguous label output based on a training process which employs a combination of supervised learning and unsupervised learning. Machine learning engine outputs corresponding to supported labels can be trained using a supervised learning training process where the training data contains desired responses for the outputs. A cost function may be configured to facilitate simultaneous training of a plurality of outputs provided by the machine learning engine that combines both the supervised and unsupervised training processes described above. Advantageously, training both process in tandem as a multi-objection optimization problem rather than two separate optimization problems will more likely yield a global optimum. Such training processes which combine supervise and unsupervised learning may incorporate regulation processes which preclude the training from deciding that all training data elements are ambiguous.

For example, an embodiment of a regulation process may include limiting the number of training data elements that can be considered ambiguous. Furthermore, in configuring a training process to maximize prediction accuracy, a secondary objective can be included to regulate or limit the number of training data elements considered ambiguous below a pre-defined amount, which may be referred to as an ambiguous budget. In an embodiment, a cost function is configured to implement an ambiguous budget, the cost function having a first component for penalizing incorrect predictions and a second component for penalizing exceeding the ambiguous budget.

For example, the Binary Cross-Entropy Loss function can be used to quantify the correctness of a Prediction for one Input Data:

$${L}_{b c e} = - \frac{1}{{n}_{c}} {\sum }_{j = 1}^{{n}_{c}} ( {y}_{j} log {\hat{y}}_{j} + ( 1 - {y}_{j} ) log ( 1 - {\hat{y}}_{j} ) )$$

where:
n_{c} is the number of Labels in the set of Supported Labels
j is the index for Label j
yⱼ is the value 1 if the Input Data should yield a Prediction of Label j and 0 otherwise
ŷⱼ is the Machine Learning Engine output corresponding to Label j

Then, the following Loss Function can be used to quantify the amount to which the Ambiguous Budget is exceeded:

$${L}_{a}^{[ t ]} = max ( 0 , - log ( 1 - \frac{{n}_{a}^{[ t - 1 ]} - γ}{m - γ} ) ) \\ {n}_{a}^{[ t ]} = β {n}_{a}^{[ t - 1 ]} + ( 1 - β ) {C}^{[ t ]}$$

where:
t is the training mini-batch index
C^{[t]} is a count of the number of Ambiguous Predictions in minibatch t,
nₐ^{[t]} is an exponentially weighted moving average of the number of Ambiguous Predictions ending at batch t,
β is the decay factor of the exponentially weighted moving average
m is the number of Training Data Elements in a minibatch, and
γ is a soft budget of the number of permitted Ambiguous predictions per mini-batch.

The final Cost Function across the entire Training Data set is as follows:

$$cost = \frac{1}{m} {\sum }_{i = 1}^{m} ( α {\hat{y}}_{a}^{( i )} {L}_{a}^{[ t ]} + ( 1 - {\hat{y}}_{a}^{( i )} ) {L}_{b c e}^{( i )} )$$

where:
m is the number of elements in the Training Data
i is the Training Data Element index,
L_{bce}⁽ⁱ⁾ is the Binary Cross-Entropy Loss for Training Data Element i,
ŷₐ⁽ⁱ⁾ is the Ambiguous Label Output value for Training Data Element i, and
α controls how aggressively to penalize exceeding the Ambiguous Budget.

Advantageously, an ambiguity-aware machine learning system configured in accordance with the foregoing may identify potentially erroneous input data because of ambiguous training data, and further mitigate impacts arising from training on ambiguous data, thereby at least mitigating or possibly eliminating issues of overfit or underfit. Furthermore, such ambiguity-aware machine learning systems advantageously do not require pre-identification of potentially ambiguous data in the training data making such an approach more general and widely applicable than other more constrained systems or approaches.

Machine learning systems may set aside a subset of training data for use in quantifying the trained system in a subsequent testing process for quantifying the quality of the trained system. This is commonly referred to as splitting the data, specifically into training data and testing data. In some instances, the test data may be further split into two sets, a test data set and a validation data set. Splitting the data may help to mitigate overfitting which may arise during the training process from ambiguity in the training data. Advantageously however, an ambiguity-aware machine learning system in accordance with the disclosure herein need not split the test data to avoid overfitting, as the additional data rather benefits the ability of the system to train and learn of indications of ambiguity in input data.

FIG. 6 illustrates an embodiment of an ambiguity-aware machine learning system 400, trained in accordance with the disclosure herein, and operating in a deployed state. The machine learning system 400 includes an ambiguity-aware machine learning engine 430 defined by associated parameters 440. The machine learning engine 430 generates an output 434 based on the input 482 and the parameters 440. The output 434 is then provided as an input to an ambiguity-aware prediction engine 460. The prediction engine 460 then generates a prediction output. For example, the prediction may generate a first output 464 indicative of a predicted label and a second output 466 indicative of an ambiguity label. In this regard, the prediction engine 460 is enhanced to output an indication of whether the input 482 is ambiguous. The first and second outputs 464 and 466 may then be supplied to other higher level systems for use in interpreting the input 482 based on the predicted label 464 and the ambiguity label 466. In an embodiment, the prediction engine 460 may selectively provide a prediction output based on assessing a plurality of inputs against a prediction criterion. In an embodiment, the prediction engine selectively provides a prediction output based on either the first output 464 indicative of a predicted label or the second output 466 indicative of an ambiguity label.

Embodiments of an ambiguity-aware prediction engine may be configured to use a function of the received inputs to selectively provide a prediction output. In an embodiment, the received inputs are an ambiguous label and a supported label and the prediction output is based on a function of the ambiguous label and the supported label wherein the prediction output is either the ambiguous label or the supported label. Other functions may be specified or learned through a machine learning system. For example, if the inputs received by the prediction engine do not meet a prediction criterion, then the prediction engine may default to outputting a predetermined input, such as defaulting to outputting the ambiguous label input. In an embodiment, inputs provided to the prediction engine are provided in the form of a vector, wherein each vector element corresponds to a specific label. In such implementations, the prediction engine may for example compare the largest value in the vector against a criteria, such as a minimum threshold criteria, and further output an ambiguous prediction when the largest value in the vector does not exceed a first threshold value. As a further example, the prediction engine may implement additional criteria to assess whether any value in a vector, other than the largest value(s), exceeds a second threshold value, wherein the first and second threshold values may or may not be the same. In such a scenario, if either criteria are not met, then the prediction engine may default to outputting the ambiguous label. As yet a further example, the prediction engine may compare the relative difference of a first vector element and a second vector element against a threshold value. If the relative difference does not exceed a threshold value, the prediction engine may default to outputting a particular input, such as an ambiguous label. In an embodiment, the first vector element is the largest vector element, and the second vector element is the second largest vector element.

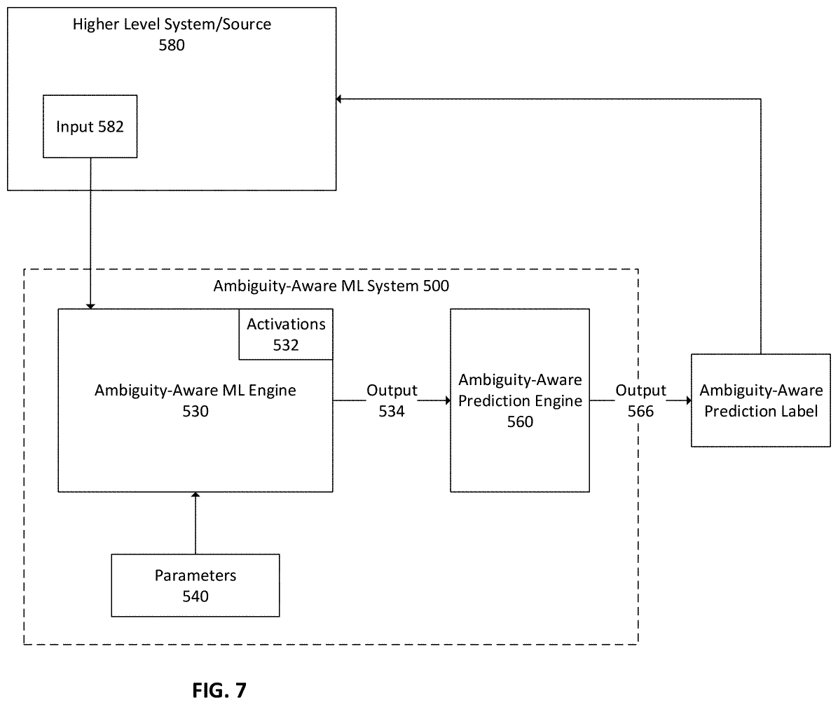

FIG. 7 illustrates an embodiment of an ambiguity-aware machine learning system 500 in accordance with the disclosure herein, such as ambiguity-aware machine learning system 400 disclosed in FIG. 6, trained in accordance with the disclosure herein, and operating in a deployed state. The machine learning 500 may differ from other machine learning systems disclosed herein, by virtue of the prediction engine 560 outputting a singular ambiguity-aware prediction label 566. In particular, instead of separate outputs for predicted labels and ambiguous labels, the prediction engine 560 may be configured to output, as a function of an output 534 of the ambiguity-aware machine learning engine 530, an ambiguity-aware prediction label 566. The ambiguity-aware prediction label 566 may be a label from the set of labels supported by the machine learning systems 500, or a label, such as an ambiguous label, that indicates that the input 582 is ambiguous.

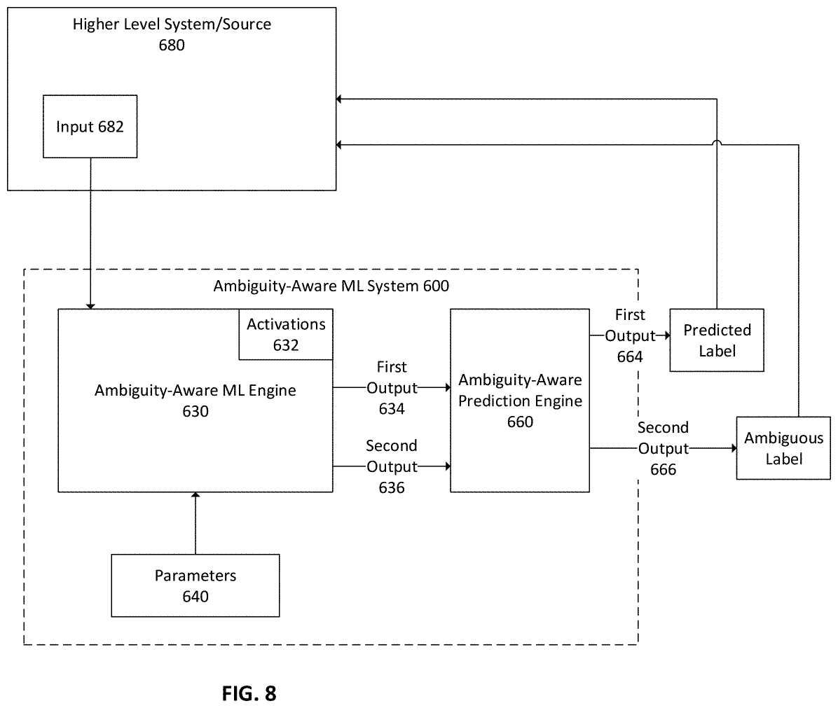

FIG. 8 illustrates an embodiment of an ambiguity-aware machine learning system 600 in accordance with the disclosure herein, such as ambiguity-aware machine learning system 400 disclosed in FIG. 6, trained in accordance with the disclosure herein, and operating in a deployed state. In this embodiment, the machine learning system 600 includes an ambiguity-aware machine learning engine 630 conditioned on the basis of the associated parameters 640 to generate an output corresponding to a label in the set of supported labels or ambiguous labels for a given input 682. In particular, the machine learning engine 630 is configured to produce a first output 634 associated with a supported label, and a second output 636 associated with an ambiguous label. The first and second outputs 634 and 636 are supplied to an ambiguity-aware prediction engine 660 in accordance with the disclosure herein, which receives an additional input corresponding to an ambiguous label 636. The prediction engine 660 then provides first and second output 664 and 666 corresponding to a predicted label and an ambiguous label, respectively. In an embodiment, the prediction engine 660 outputs a single ambiguous-aware prediction label encoded with a predicted label and an ambiguous label.

Embodiments of an ambiguity-aware prediction engine as disclosed herein may be configured to utilize additional outputs generated by an ambiguity-aware machine learning engine. For example, the prediction engine may be configured to utilize an output from a machine learning engine that corresponds to an ambiguous label. In an embodiment, the prediction engine may provide a prediction output corresponding to the input label having the largest value. In an embodiment, the output of the prediction engine is a supported label or an ambiguous label. In an embodiment, the prediction engine may output a prediction label corresponding to an input associated with a label wherein the input is above a threshold associated with a prediction criteria. In an embodiment, the prediction engine provides a prediction output based on an input associated with an ambiguous label when the input is above a threshold associated with a threshold criteria, regardless of other input values.

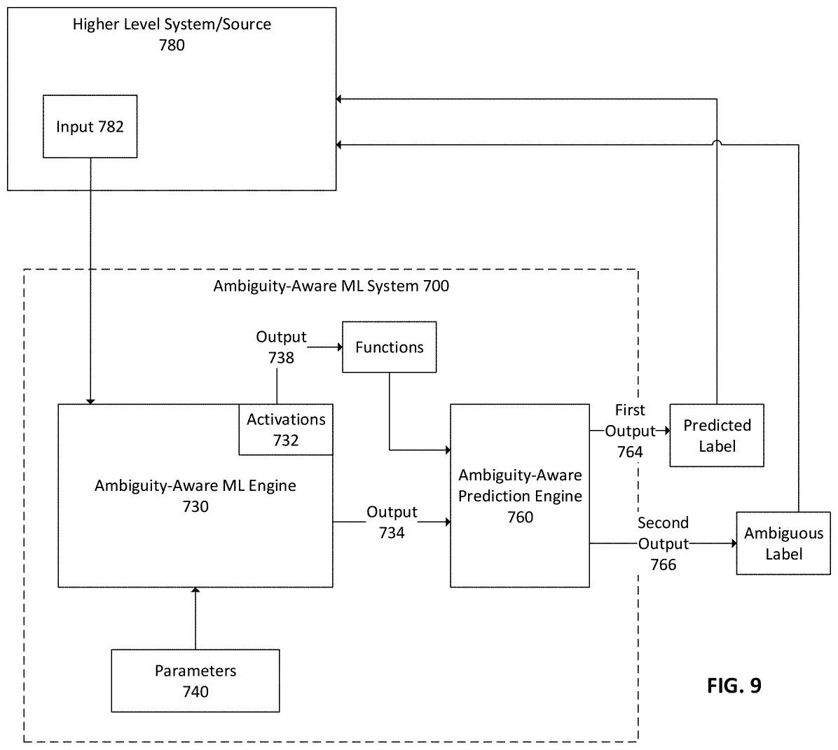

FIG. 9 illustrates an embodiment of an ambiguity-aware machine learning system 700 in accordance with the disclosure herein, trained in accordance with the disclosure herein, and operating in a deployed state. The ambiguity-aware machine learning engine 730 includes internal activation values 732 and may be configured in a manner similar to other ambiguity-aware machine learning engines disclosed herein, such as ambiguity-aware machine learning engines 400, 500, and 600. However, the machine learning engine 730 differs in that, it generates an additional output 738 based on specified functions of the internal intermediate activation values 732 for input to the prediction engine 760. The prediction engine 760 then provides first and second outputs 764 and 766 corresponding to a predicted label and an ambiguous label, respectively. In an embodiment, the prediction engine 760 outputs a single ambiguous-aware prediction label encoded with a predicted label and an ambiguous label.

Embodiments of ambiguity-aware machine learning engine may be configured to produce a plurality of additional outputs as a function of associated internal activation values of the. The machine learning engine provides the additional outputs to a prediction engine to aid in determining whether input data is ambiguous. For example, a function may calculate or approximate a vector distance between vectors composed of activation values corresponding to machine learning engine outputs associated with each label. For each input data input to the machine learning engine, the function calculations the vector distance to all labels. The plurality of vector distances are then provided to the prediction engine for use in identifying ambiguous data. For example, the prediction may generate an output marked as ambiguous if the vector distance between any two labels is below a threshold value. As a further example, the machine learning engine may be configured to output the result of calculating or approximating the distance in the input data space of the input data to the learned class decision boundaries of the trained machine learning engine. The prediction engine may be further configured to use this additional information to determine whether the input data is ambiguous or not. For example, if the distance of the input data to one or more class decision boundaries is below a threshold, the prediction engine can output the ambiguous label. In another embodiment, the machine learning engine is configured to output the result of a distance between an internal activation(s) and the class decision boundary.

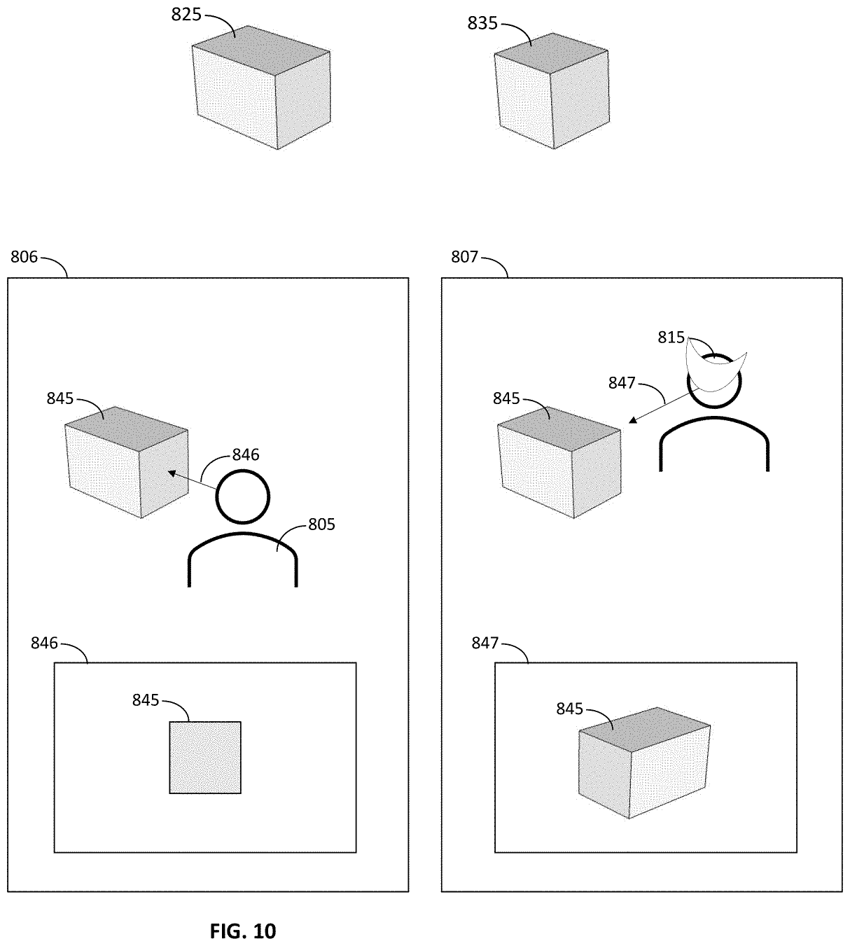

FIG. 10 is a diagram illustrating a mixed-reality application of an ambiguity-aware machine learning system as disclosed in accordance with the disclosure herein, such as ambiguity-aware machine learning systems 200, 300, 400, 500, 600, and 700. A mixed reality system 815 as for example those that may be worn or used by a user 805 and may comprise well known systems such as Google Glass or the like, or otherwise comprise conventional components such as a headset coupled with a display that can be positioned proximal to a user's eyes, including corresponding sensors communicatively coupled to the display for acquiring data indicative of the physical environment. Such sensors may include but are not limited to, cameras, video cameras, infra-red sensors, heat sensors, and so forth. Mixed-reality systems and the like may also be implemented using mobile devices, and laptops. Mixed reality systems 815 may be used to obtain information about objects in an environment, such as acquiring image data of objects. Such image data may be provided as an input to a machine learning system in accordance with the disclosure herein to make a prediction or otherwise identify what the object is. As a simple example, FIG. 10 includes two three-dimensional objects 825 and 835. The first object 825 is more rectangular in shape, while the second object 835 is more cube-like. Thus, while the two objects are different, depending on the perspective, they may look identical and thus image data for each object may be too ambiguous to identify the correct object depending on the perspective of the image. For example, from a first perspective 806, the user 805 can use the mixed-reality system 815 to acquire image data of an object 845 indicative of a first observation 846 of the object 845. The first observation 846 is a side profile of the object 845 and resembles a square shape. Accordingly the first observation 846 is ambiguous as it does not include enough information to accurately predict whether the object 845 is in fact the first object 825 or the second object 835, as each of the first and second object 825 and 835 include a side profile that reflects a square-shape. Thus, machine learning engines incapable of handling ambiguity would either incorrectly identify the object 845 or correctly identify it but for the wrong reasons. However, an ambiguity-aware machine learning system in accordance with the disclosure herein would be able to mitigate the impact of the ambiguity by identify the image data as ambiguous and provide an appropriate indication of ambiguity in any output from the system. For example, an ambiguity-aware machine learning system could provide an ambiguous label as an output, and otherwise defer identifying the object until further image data is obtained capable of disambiguating the observed objects from a known classes of objects.

From a second perspective 807, the user 805 can acquire further image data of the object 845 indicative of a second observation 847 of the object 845. The second observation 847 is a perspective view of the object 845 that illustrates a longer more rectangular body, in addition to the square side profile identified in the first observation 846. Based on the second observation 847 alone, the image data enables accurate prediction that the object 845 is indeed the rectangular first object 825, and the ambiguity-aware machine learning system can output a non-ambiguous output based on the image data acquired from the second observation 847.

The sensor associated with the mixed reality system 815 may be a video camera that continuously captures a sequence of frames of image data. This mixed reality system 815 may be further configured to track and remember the observed ambiguous and non-ambiguous objects through known techniques such as video tracking and object tracking. For example, the system may be configured to remember the non-ambiguous prediction even when the user is positioned in the first perspective 806.

A mixed reality system may be configured to interpret physical objects in an environment using one or more sensors that acquire and supply data to a machine learning system. The machine learning system may be configured to output a set of predictions for locations of objects of interest and/or the kind of the objects. As the user of the mixed-reality system moves through the physical environment or when a physical object in the environment moves, the physical object may appear differently to the sensor, providing new information which may help to resolve or disambiguate the object from other similar objects. For example, a camera may acquire or capture 2D image data from different perspectives of a real-world 3D object and thereby provide different image data of the object. In other words, the direction of observation affects the input data to the machine learning system, which in turn affects predictions. A common situation that arises is that from certain directions of observation of an object, the 2D project does not contain enough information to disambiguate the object, leading to ambiguous input data. Using an ambiguity-aware machine learning system in this situation is advantageous. In an embodiment, a mixed reality system further comprises a computer-readable medium having instructions stored thereon that when executed by a computer provide an ambiguity-aware machine learning system in accordance with the disclosure herein.

In an embodiment, the ambiguity-aware mixed reality system may be configured to supply sensor data to an ambiguity-aware machine learning system. Then, in the case of receiving ambiguous input data, instead of making a potentially erroneous prediction based on the ambiguous data the machine learning system can output an indication that the input data is ambiguous. The ambiguity-aware mixed reality system can then react accordingly by for example, deferring taking an action on the object instead of taking an action that may be inappropriate or erroneous, thereby improving user experience. In an embodiment, once an object is identified, it is displayed in the mixed-reality with an advertisement or social media post corresponding to the nature of the object or corresponding to other media and/or identifiers associated with the object.

Sensors in a mixed reality system may be configured to continuously capture data over time. For example, the sensor may be a camera configured to continuously capture image data at a certain amount of frames per second, each frame corresponding to an image. As frames are captured by the sensor, they may be individually supplied to an ambiguity-aware machine learning system to produce a stream of predictions. Embodiments of an ambiguity-aware mixed reality system may be configured to resolve ambiguity of an observed object at a future time. For example, at some point in time, or for some given frame of a video stream, the ambiguity aware machine learning system may indicate that the frame of image data contains ambiguous input data. Areas of the image data that are observed to be ambiguous input data may be interpreted as ambiguous objects. An ambiguous object is potentially an object of interest for which there is not yet enough information for the ambiguity-aware machine learning system to confidently understand. At some future point in time, or in other words in some subsequent frame of the video stream, the view of an ambiguous object may have changed, due to either the user having moved, or the physical object having moved, such that the ambiguity-aware machine learning system now produces a non-Ambiguous prediction. The ambiguity-aware mixed reality system can then react to the object with the understanding that it appeared ambiguous at some point in time, and subsequently unambiguous at a later point in time. Embodiments of an ambiguity-aware mixed-reality system may be configured with video tracking and/or visual odometry (such as, but not limited to, the use of egomotion algorithms) to track the movement of objects, users, and other aspects of the immediate physical environment. It is possible however that at an even later point in time, the view of the object leads back to an ambiguous indication. Accordingly, embodiments of an ambiguity-aware mixed reality system may be configured such that if at any point in time, a non-ambiguous prediction was made, then any subsequent ambiguous prediction made of the object is ignored. Embodiments further include an ambiguity-aware mixed reality system having a history of prediction for resolving ambiguity conflicts that may arise over time for the same object. The mixed reality system may then act accordingly depending on the goals of the mixed reality System.

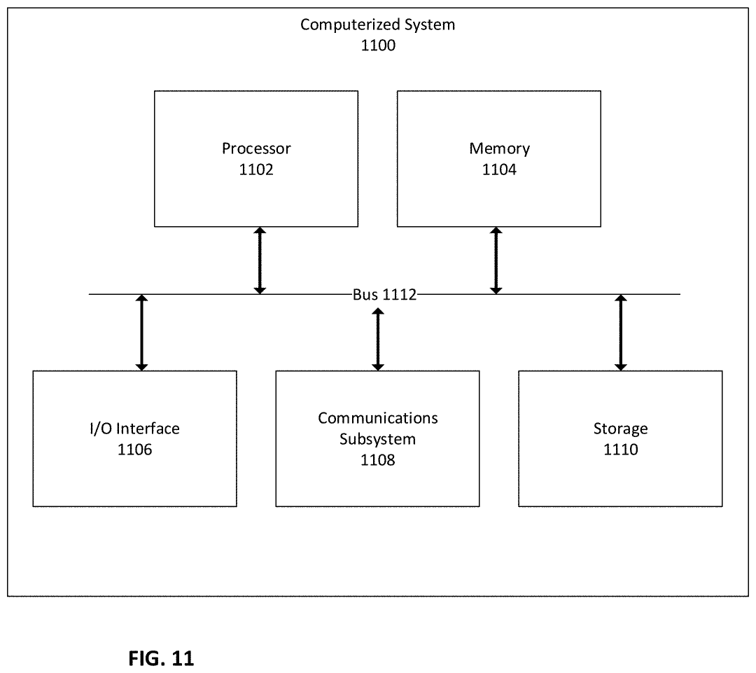

FIG. 11 is a block diagram of an example computerized device or system 1100 that may be used in implementing one or more aspects or components of an embodiment of an ambiguity-aware machine learning system according to the present disclosure. For example, system 1100 may be a mixed-reality system configured according to an embodiment of the present disclosure.

Computerized system 1100 may include one or more of a processor 1102, memory 1104, a mass storage device 1110, an input/output (I/O) interface 1106, and a communications subsystem 1108. Further, system 1100 may comprise multiples, for example multiple processors 1102, and/or multiple memories 1104, etc. Processor 1102 may comprise one or more of a digital processor, an analog processor, a digital circuit designed to process information, an analog circuit designed to process information, a state machine, and/or other mechanisms for electronically processing information. These processing units may be physically located within the same device, or the processor 1102 may represent processing functionality of a plurality of devices operating in coordination. The processor 1102 may be configured to execute modules by software; hardware; firmware; some combination of software, hardware, and/or firmware; and/or other mechanisms for configuring processing capabilities on the processor 1102, or to otherwise perform the functionality attributed to the module and may include one or more physical processors during execution of processor readable instructions, the processor readable instructions, circuitry, hardware, storage media, or any other components.

One or more of the components or subsystems of computerized system 1100 may be interconnected by way of one or more buses 1112 or in any other suitable manner.

The bus 1112 may be one or more of any type of several bus architectures including a memory bus, storage bus, memory controller bus, peripheral bus, or the like. The CPU 1102 may comprise any type of electronic data processor. The memory 1104 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The mass storage device 1110 may comprise any type of storage device configured to store data, programs, and other information and to make the data, programs, and other information accessible via the bus 1112. The mass storage device 1110 may comprise one or more of a solid state drive, hard disk drive, a magnetic disk drive, an optical disk drive, or the like. In some embodiments, data, programs, or other information may be stored remotely, for example in the cloud. Computerized system 1100 may send or receive information to the remote storage in any suitable way, including via communications subsystem 1108 over a network or other data communication medium.

The I/O interface 1106 may provide interfaces for enabling wired and/or wireless communications between computerized system 1100 and one or more other devices or systems. For instance, I/O interface 1106 may be used to communicatively couple with sensors, such as cameras or video cameras. Furthermore, additional or fewer interfaces may be utilized. For example, one or more serial interfaces such as Universal Serial Bus (USB) (not shown) may be provided.

Computerized system 1100 may be used to configure, operate, control, monitor, sense, and/or adjust devices, systems, and/or methods according to the present disclosure.

A communications subsystem 1108 may be provided for one or both of transmitting and receiving signals over any form or medium of digital data communication, including a communication network. Examples of communication networks include a local area network (LAN), a wide area network (WAN), an inter-network such as the Internet, and peer-to-peer networks such as ad hoc peer-to-peer networks. Communications subsystem 1108 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1394), Thunderbolt™, WiFi™ (e.g. IEEE 802.11), WiMAX (e.g. IEEE 802.16), Bluetooth™, or Near-field communications (NFC), as well as GPRS, UMTS, LTE, LTE-A, and dedicated short range communication (DSRC). Communication subsystem 1108 may include one or more ports or other components (not shown) for one or more wired connections. Additionally or alternatively, communication subsystem 1108 may include one or more transmitters, receivers, and/or antenna elements (none of which are shown).

Computerized system 1100 of FIG. 11 is merely an example and is not meant to be limiting. Various embodiments may utilize some or all of the components shown or described. Some embodiments may use other components not shown or described but known to persons skilled in the art.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method of generating prediction output in a machine learning system having a machine learning engine and a prediction engine, the method comprising:
receiving a data input at the machine learning engine;
generating, by the machine learning engine, an output associated with the data input based on a set of internal parameters and transmitting the output to the prediction engine;
determining, at the prediction engine, a label from a set of possible labels and an ambiguous indication based on the machine learning engine output and a prediction function;
generating a prediction output that indicates the determined label and the determined ambiguous indication.

2. The method of claim 1, wherein determining the ambiguous indication comprises:
comparing the machine learning engine output to a criterion;
if the criterion is not met, the determined ambiguous indication indicates that the determined label is ambiguous.

3. The method of claim 2, wherein:
the output generated by the machine learning engine is an output vector where each location of the vector output is associated with a label from the set of possible labels;
the criterion is a minimum threshold value; and
comparing the output to the criterion comprises comparing the largest value of the output vector to the minimum threshold value such that the criterion is not met if the largest value does not exceed the minimum threshold value.

4. The method of claim 3, wherein:
the criterion further includes a second threshold value; and
comparing the machine learning engine output to the criterion further comprises comparing each value of the output vector that are other than the largest value to the second threshold value such that the criterion is not met if any of the other values exceed the second threshold value.

5. The method of claim 1, wherein generating, by the machine learning engine, an output associated with the data input comprises generating, by the machine learning engine, an additional output to provide additional information to the prediction engine for determining the ambiguous indication.

6. The method of claim 5, wherein determining, by the prediction engine, the ambiguous indication comprises:
comparing the additional output generated by the machine learning engine to pre-defined conditions; and
if the additional output meets pre-defined conditions, the determined ambiguous indication indicates that the determined label is ambiguous.

7. The method of claim 5, wherein determining the ambiguous indication comprises:
comparing the additional output from the machine learning engine to a criterion;
if the additional output does not meet the criterion is not met, the ambiguous indication is asserted.

8. The method of claim 2, further comprising:
performing a training process by the machine learning engine utilizing training data and a cost function to determine the set of internal parameters,
utilizing the cost function to calculate a cost associated with the determined ambiguous indication indicating that the label determined by the prediction engine is ambiguous by not meeting the criterion.

9. The method of claim 8, wherein the cost function is a sum of a cost associated with incorrectly determining the ambiguous indication as indicating the determined label is not ambiguous and a cost associated with incorrectly determining the ambiguous indication as indicating the determined label is ambiguous.

10. The method of claim 5, wherein the additional output generated by the machine learning engine is associated with an indication of ambiguity of a data input.

11. The method of claim 10, further comprising performing a training process by the machine learning engine utilizing training data and a cost function to determine the set of internal parameters,
wherein the training data utilized in the training process includes a subset of the training data that includes ambiguity indications indicating that the training inputs in the subset of training data may be considered ambiguous.

12. The method of claim 11, wherein the cost function is configured to calculate the cost associated with the additional output generated by the machine learning engine.

13. The method of claim 10, wherein the determining, at the prediction engine, the label and the ambiguous indication utilizes the additional output generated by the machine learning engine.

14. The method of claim 5, wherein the additional output is generated by the machine learning engine is a function of the internal activations of the machine learning engine.

15. The method of claim 14, wherein the function is comprised of vector distances between the activations associated with each of the outputs generated by the machine learning engine for a set of data inputs.

16. The method of claim 10, further comprising performing a training process by the machine learning engine utilizing training data and a cost function to determine the set of internal parameters,
wherein the cost function is configured to add an additional cost for each of the additional outputs that indicates the training input is ambiguous that exceeds a threshold number of ambiguous outputs.

17. A Machine learning system comprising:
a machine learning engine configured to:
receive a data input; and
generate an output associated with the data input based on a set of internal parameters and transmitting the output to the prediction engine; and
a prediction engine configured to:
determine a label from a set of possible labels and an ambiguous indication based the machine learning engine output and a prediction function; and
generate a prediction output that indicates the determined label and the determined ambiguous indication.

18. The machine learning system of claim 17, wherein the prediction engine configured to determine the ambiguous indication comprises the prediction engine configured to:
compare the machine learning engine output to a criterion;
if the criterion is not met, the determined ambiguous indication indicates that the determined label is ambiguous.

19. The machine learning system of claim 18, wherein:
the machine learning engine configured to generate the output generated comprises the machine learning engine configured to generate an output vector where each location of the vector output is associated with a label from the set of possible labels;
the criterion is a minimum threshold value; and
the prediction engine configured to compare the output to the criterion comprises the prediction engine configured to compare the largest value of the output vector to the minimum threshold value such that the criterion is not met if the largest value does not exceed the minimum threshold value.

20. The machine learning system of claim 19, wherein:
the criterion further includes a second threshold value; and
the prediction engine configured to compare the machine learning engine output to the criterion further comprises the prediction engine configured to compare each value of the output vector that are other than the largest value to the second threshold value such that the criterion is not met if any of the other values exceed the second threshold value.

21. The machine learning system of claim 17, wherein by the machine learning engine configured to generate an output associated with the data input comprises the machine learning engine configured to provide an additional output to generate additional information for determining the ambiguous indication.

22. The machine learning system of claim 21, wherein the prediction engine configured to determine the ambiguous indication comprises the prediction engine configured to:
compare the additional output generated by the machine learning engine to pre-defined conditions; and
if the additional output meets pre-defined conditions, the determined ambiguous indication indicates that the determined label is ambiguous.

23. The machine learning system of claim 21, wherein the prediction engine configured to determine the ambiguous indication comprises the prediction engine configured to:
compare the additional output from the machine learning engine to a criterion;
if the additional output does not meet the criterion is not met, the ambiguous indication is asserted.

24. The machine learning system of claim 18, wherein the machine learning engine is further configured to:
perform a training process utilizing training data and a cost function to determine the set of internal parameters,
utilize the cost function to calculate a cost associated with the determined ambiguous indication indicating that the label determined by the prediction engine is ambiguous by not meeting the criterion.

25. The machine learning system of claim 24, wherein the cost function is a sum of a cost associated with incorrectly determining the ambiguous indication as indicating the determined label is not ambiguous and a cost associated with incorrectly determining the ambiguous indication as indicating the determined label is ambiguous.

26. The machine learning system of claim 21, wherein the additional output generated by the Machine Learning Engine is associated with an indication of ambiguity of a data input.

27. The machine learning system of claim 26, wherein the machine learning engine is further configured to perform a training process utilizing training data and a cost function to determine the set of internal parameters,
wherein the training data utilized in the training process includes a subset of the training data that includes ambiguity indications indicating that the training inputs in the subset of training data may be considered ambiguous.

28. The machine learning system of claim 27, wherein the machine learning system is configured to utilize the cost function to calculate the cost associated with the additional output generated by the machine learning engine.

29. The machine learning system of claim 26, wherein the prediction engine configured to determine the ambiguous indication comprises the prediction engine configured to utilize the additional output generated by the machine learning engine to determine the ambiguous indication.

30. The machine learning system of claim 21, wherein the additional output is generated by the machine learning engine is a function of the internal activations of the machine learning engine.

31. The machine learning system of claim 30, wherein the function is comprised of vector distances between the activations associated with each of the outputs generated by the machine learning engine for a set of data inputs.

32. The machine learning system of claim 26, wherein the machine learning engine is further configured to perform a training process utilizing training data and a cost function to determine the set of internal parameters,
wherein the cost function is configured to add an additional cost for each of the additional outputs that indicates the training input is ambiguous that exceeds a threshold number of ambiguous outputs.

33. An ambiguity-aware machine learning system for identifying an object, comprising:
a user device having a sensor for acquiring information indicative of the object, the user device communicatively coupled to a processor configured by machine-readable instructions to:
generate image data based on the information acquired by the sensor, the image data indicative of a first perspective of the object;
generate, using a machine learning engine, an output based on applying a set of machine learning parameters associated with the machine learning engine to the image data;
generate, using a prediction engine, an output label and an ambiguous indication based on the machine learning engine output and a prediction function associated with the prediction engine, and
generate a prediction output that includes the output label and the ambiguous indication corresponding to the object.

34. The system of claim 33, wherein the processor is further configured by the machine-readable instruction to:
compare the prediction output to a criterion, and output an indication that the output label is ambiguous if the prediction output does not meet the criterion.

35. The system of claim 34, wherein when the prediction output does not meet the criterion, the processor if further configured by the machine-readable instruction to:
generate the image data based on further information acquired by the sensors, the image data indicative of a further perspective of the object different from the first perspective of the object.

36. The system of claim 34, wherein when the prediction output does not meet the criterion, the processor is further configured by the machine-readable instruction to:
generate image data based on further information acquired by the sensor, the image data indicative of a plurality of perspectives of the object.

37. The system of claim 33, wherein the user device is a mixed-reality device and the sensor is a camera.

38. The system of claim 37, wherein the mixed-reality device is a headset having a heads-up display.

39. The system of claim 33, wherein when the prediction output does meet the criterion, the object is identified and visualized on a display associated with the user device, wherein the object is displayed with an advertisement or social media interaction associated with a class or characteristic of the object.

40. A method for training a machine learning system to identify and mitigate ambiguity, the method comprising:
training a machine learning engine using a training set comprising a plurality of input data associated with a corresponding plurality of known labels, wherein a subset of the plurality of input data is further associated with a corresponding ambiguity label;
generating, during training of the machine learning engine, for each of the plurality of input data in the training set, a first machine learning output indicative of a potential label associated with an input data and a second machine learning output indicative of a potential ambiguity associated with the input data;
generating, using a cost function, a cost output for each of the plurality of input data based on the first machine learning output and the second machine learning output;
adjusting a set of parameters associated with the machine learning engine based on the cost function, wherein the set of associated parameters condition the behaviour of the machine learning engine.

41. The method of claim 40, wherein the subset of the plurality of input data includes all of the plurality of input data.

42. The method of claim 41, wherein the cost function is configured to limit the use of ambiguous labels.

43. The method of claim 40, wherein the cost output includes a first cost based on comparing the first machine learning output with a known label associated with the input data, and a second cost based on comparing the second machine learning output with, if available, an ambiguity label associated with the input data.

44. The method of claim 43, wherein the cost function assigns the known label or the ambiguity label to the cost output based on a relative difference between the first cost and the second cost.

45. The method of claim 43, wherein the first cost is based on miss-predicting that the input data should have the potential label corresponding to the first machine learning output and miss-predicting that the input data should not have the potential label corresponding to the first machine learning output.

46. The method of claim 45, wherein the second cost is based on miss-predicting that the input data should have the potential ambiguity associated with the second machine learning output and miss-predicting that the input data should not have the potential ambiguity associated with the second machine learning output.

47. The method of claim 40 further comprising, annotating the set of training data to include a plurality of desired responses correspondingly associated with the plurality of input data.

48. The method of claim 40 further comprising, generating a plurality of desired responses based on applying an unsupervised learning process to the second machine learning output and annotating the set of training data to correspondingly associate the plurality of desired responses with the plurality of input data.

49. The method of claim 48, wherein the desired response is an indication of ambiguity based on applying a clustering algorithm to the plurality of input data.

50. The method of claim 40, wherein the training process further comprises an ambiguous budget for limiting a number of the plurality of input data that can be considered ambiguous.

51. The method of claim 50, wherein the cost function generates a first penalty for an incorrect prediction and generates a second penalty for exceeding the ambiguous budget.

52. The method of claim 51, wherein the incorrect prediction is based on a Binary Cross-Entropy Loss function for quantifying a correctness of a prediction.
